(19) United States
(12) Patent Application Publication
(10) Pub. No.: US 2019/0187875 A1
(43) Pub. Date: Jun. 20, 2019

(54) REMOTE CONTROL INCORPORATING HOLOGRAPHIC DISPLAYS

(71) Applicant: International Business Machines Corporation, Armonk, NY (US)

(72) Inventors: Eric V. Kline, Rochester, MN (US); Sarbajit K. Rakshit, Kolkata (IN)

(21) Appl. No.: 15/843,183

(22) Filed: Dec. 15, 2017

(51) Int. Cl. G06F 3/0481; G06F 3/0482; G06F 3/0484; G06F 3/0488

(52) U.S. Cl. CPC G06F 3/04815; G06F 3/0482; G06F 2203/04806; G06F 3/04883; G06F 3/04842

(57) ABSTRACT

Embodiments of the invention are directed to methods and systems for remotely controlling a volumetric or holographic display. The method includes displaying a hemispheric touch area in the vicinity of the remote control; detecting a selection in the hemispheric touch area; mapping the selection to the volumetric display controlled by the remote control; and controlling the volumetric display based on the selection in the hemispheric touch area.

### BACKGROUND

The present invention relates in general to the field of computing. More specifically, the present invention relates to systems and methodologies for remote control devices that incorporate holographic displays and control three-dimensional displays.

Display technologies are constantly evolving. While standard definition televisions (SDTV) were commonplace less than twenty years ago and 1280×720 pixel displays qualified as high definition televisions (HDTV) just ten years ago, displays are becoming bigger, thinner, and with greater resolution (e.g., 4K ultra-high definition (UHD) and 8K UHD) than ever before. Along with the increase in resolution and quality come innovative new display techniques. These include techniques such as 360 degree video (also known as immersive video or spherical video), that enables a viewer to control what portion of a camera's view is active; holographic displays, which use light diffraction to create a virtual three-dimensional image of an object; and other volumetric displays that form a visual representation of an object in three dimensions. It is desirable to have a way to control the display of content on new display technologies.

### SUMMARY

Embodiments of the invention are directed to methods and systems for remotely controlling a volumetric or holographic display. The method includes Embodiments of the invention are directed to methods and systems for remotely controlling a volumetric or holographic display. The method includes displaying a hemispheric touch area in the vicinity of the remote control; detecting a selection in the hemispheric touch area; mapping the selection to the volumetric display controlled by the remote control, and controlling the volumetric display based on the selection in the hemispheric touch area.

Embodiments of the present invention are further directed to a remote control for controlling a volumetric display. The remote control includes a memory, a processor system communicatively coupled to the memory, and a holographic display. The processor is configured to perform a method that includes displaying a hemispheric touch area in the vicinity of the remote control using the holographic display; detecting a selection in the hemispheric touch area; mapping the selection to the volumetric display controlled by the remote control; and controlling the volumetric display based on the selection in the hemispheric touch area.

Embodiments of the invention are directed to a computer program product for remotely controlling a volumetric display. The method includes displaying a hemispheric touch area in the vicinity of the remote control; detecting a selection in the hemispheric touch area; mapping the selection to the volumetric display controlled by the remote control, and controlling the volumetric display based on the selection in the hemispheric touch area.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter that is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 is a diagram illustrating a remote control of one or more embodiments;

FIG. 2 is a diagram illustrating the operation of one or more embodiments;

FIG. 3 is a diagram illustrating the operation of one or more embodiments;

FIG. 4 is a flow diagram illustrating the operation of one or more embodiments;

FIG. 5 is a block diagram of a computer system that can be used to implement one or more embodiments; and

FIG. 6 is a block diagram illustrating a computer program product that can be used to implement one or more embodiments.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of embodiments of the invention, as described above, display technologies have improved and there is a desire to have improved control of displays. Remote controls are commonly used to control displays. A remote control commonly utilizes input technologies such as key pads, touchscreens, and the like incorporated into a handheld device that communicates with a display in one of a variety of wires communication methods (such as using infrared (IR) or radio frequency (RF) technologies). Such technologies can control simple tasks, such as changing a channel, selecting an input, and other tasks that can be performed using simple push button commands. However, existing remote control technologies are limited in the ability to control more sophisticated aspects of displays.

Turning now to an overview of the aspects of embodiments of the invention, one or more embodiments of the invention address the above-described shortcomings of the prior art by incorporating a holographic projector with a remote control to enable better control of different types of displays.

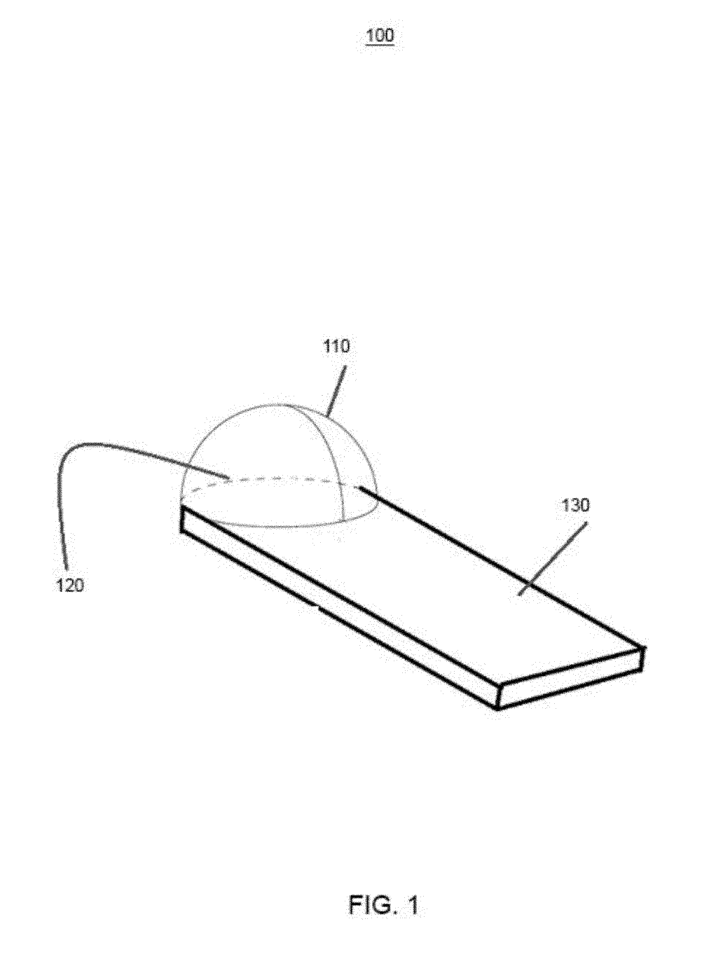

With reference to FIG. 1, an exemplary remote control 100 of one or more embodiments is illustrated. Remote control 100 can include a button area 130. Button area 130 can include buttons that are traditionally used in remote controls, such as number buttons, arrow buttons, setup buttons, mode switching buttons, and the like.

Remote control 100 also includes a touch area 110. Incorporated within touch area 110 is a holographic projector 120. Touch area 110 can be a virtual boundary that is projected by remote control 100 (such as holographic projector 120). Holographic projector 120 can be configured to display holographic images on touch area 110. In such a manner, a user is able to manipulate touch area 110 with a variety of different gestures that would be replicated on an external display (not shown). For example, the user can use a variety of gestures to signify the rotation of touch area 110. In some embodiments, the user can mimic a rotation motion within touch area 110. Thereafter, commands are sent via remote control 100 to the external display to result in the rotation of the items being displayed. Such a feature can be very useful for 360-degree video, holographic video, volumetric video, and the like.

In some embodiments, holographic projector 120 can be located external to remote control 100. For example, holographic projector 120 can be located along with external display (not shown). In such an embodiment, one portion of the external display can display a larger image and another portion of the external display can project a touch area 110 and the respective smaller image.

In a 360-degree video, because the image being captured covers an entire 360-degree field of view, there is no need for a “default” view. Most traditional displays cannot display the entire image being captured for 360-degree video, so there is a desire to allow users to adjust the image being displayed. Current techniques utilize a mouse or a joystick to provide such functionality. Using holographic projector 120 in conjunction with touch area 110 allows the user to be able to “preview” the changes being made to the displayed image. Holographic projector 120 can be configured to present a preview of the image shown in the external display. For example, as the user makes gestures to initiate a rotation, the image being displayed by holographic projector 120 also rotates. In such a manner, the user is able to more precisely change the image as he is able to see a real-time change via the image being projected by holographic projector 120.

In a similar manner, a user might desire to change the location and/or viewing angle of a three-dimensional image from a holographic or volumetric display, without having to physically change position. Rather than requiring a user to physically move in order to change his viewing angle, a user might desire an effective method to control the visual content of a holographic or volumetric display.

In addition to being able to rotate the view, the user can be able to zoom in (or magnify) or zoom out on particular areas that are being displayed. Through the use of touch area 110, the user is able to use a variety of gestures to indicate zooming in or zooming out.

In some embodiments, touch area 110 is in a hemispherical shape, to more accurately mimic the three-dimensional content of the external display. In other embodiments, a spherical shape can be used. Other shapes (such as conical, cubical, elliptical, rectangular, and the like) also can be used.

In some embodiments, certain areas of touch area 110 can provide additional functionality, based on the content being shown via holographic projector 120. For example, portions of touch area 110 can allow control of basic features of the external display. There can be a portion of touch area 110 where a user can adjust volume, control settings, change channels, change input sources, powering off, and the like. In some embodiments, a user can activate portions of touch area 110 through the use of button area 130.

In some embodiments, portions of touch area 110 can be reactive to content being displayed. Based on the content being displayed, portions of touch area 110 can have different functionality. For example, during a sporting event, touch area 110 can be adaptive to what is being displayed on the external display. If a specific player is being displayed, pressing the portion being played on touch area 110 to view statistics, biographical information, and the like regarding that player. If a team is being displayed (such as on a scoreboard), pressing on the team name on touch area 110 can lead to other information about the team, such as a schedule, roster, and the like.

Those portions of touch area 110 also can lead to a website or some other vendor where a person can sell or purchase items. Referring again to the sports example, the portion of touch area 110 can lead to jerseys featuring an individual player, a place to buy or sell tickets, or other souvenirs related to the team or player.

Such features are not limited to sporting events. If a cooking show is being displayed, portions of touch area 110 can lead to places to purchase ingredients or appliances or can lead to recipes of the items being prepared. If a news show is being displayed, portions of touch area 110 can lead to information about the subject matter being discussed. If a weather forecast or traffic alert is being displayed, additional information can be available via a context-sensitive menu displayed on a portion of touch area 110. The user would activate touch area 110 and then access the menu for the additional information.

In some embodiments, a favorite vendor can be chosen beforehand, with the user's payment and shipping information being submitted. In such a manner, interacting with portions of touch area can directly result in a purchase of an item being displayed, whether the item being displayed is in a commercial, in a news program, in a shopping program, and the like. In some embodiments, a confirmation alert may be displayed in order to prevent inadvertent purchases (a user merely wanted information about the object, not to purchase the object.)

In some embodiments, such interactive features can utilize information that is supplied by a broadcaster. The broadcaster would activate portions of touch area 110 based on the information being shown. The broadcaster would then change the portions of touch area 110 based on the information being displayed. In some embodiments, machine learning and machine vision capabilities can be used to change the portions of touch area 110. Machine vision capabilities would determine what is being displayed on the external display and holographic projector 120 and dynamically change portions of touch area 110 based on the displayed content.

The above-described features can also be implemented using holographic objects displayed on portions of touch area 110. For example, a shopping cart can be placed on a portion of touch area 110. Thereafter, a user can “drag” the shopping cart to an item of interest that is being displayed via holographic projector 120. Similar objects can be present for additional information, statistics, and the like.

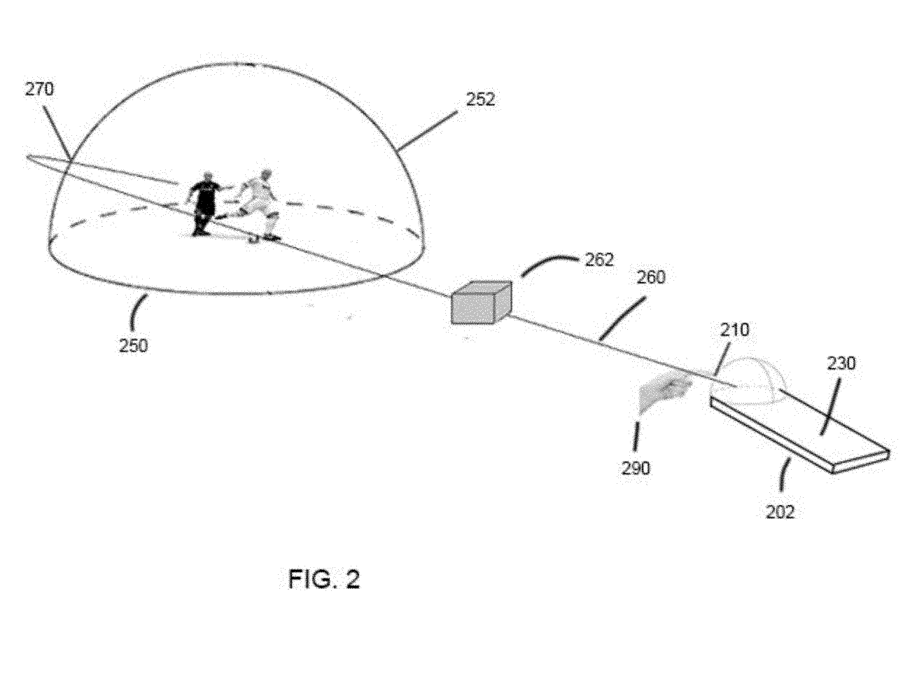

In some embodiments, a user can manipulate items by “drawing” on touch area 110. For example, during a sporting event, a user can touch a player's jersey, then drag the jersey to a shopping cart that is displayed on a portion of touch area 110. A movement can be visually initiated from the display to the shopping cart. Because the external display may be a three-dimensional image, the objects on the external display can appear to be traveling from the external display to the shopping cart icon that is located on touch area 110. Such an embodiment is illustrated in FIG. 2.

FIG. 2 illustrates an external display 250 being used in conjunction with a remote 202. Remote 202 can include a touch area 210 along with a button area 230. External display 250 shows holographic (or volumetric) contents and a surrounded boundary 252. Touch area 210 mimics surrounded boundary 252.

As the user 290 contacts touch area 210, the corresponding touch point 270 of external display 250 is determined. In FIG. 2, the user has “dragged” a player's jersey to a shopping cart. Therefore, the holographic object 262 moves along a path 260 from external display 250 to remote 202. As shown in FIG. 2, object 262 is “traveling” from external display 250 to touch area 210 of remote 202. Such an interaction can occur by having user 290 drag the desired content to touch area 210 or otherwise drawing a line from external display 250 to touch area 210. It should be understood that the holographic object can move along path 260 in either direction. For example, instead of the object moving towards a shopping cart displayed on touch area 210, the cart could move toward external display 250. Such movements can be detected in one of a variety of different manners. For example, a three-dimensional sensor can be present in remote 202 that detects movements in front of remote 202 and initiate the movement toward the destination on touch area 210. In addition, while a drag motion is illustrated in FIG. 2, it should be understood that a rotation or zoom can be initiated, with the corresponding touch point 270 being rotated/zoomed the same amount as the user's motions in touch area 210.

It should be understood that remote 202 can be in one of a variety of different sizes. Remote 202 may be capable of being handheld, such as a traditional television remote control. In other embodiments, remote 202 may be larger and intended to be placed on a coffee table or other large surface instead of being hand held.

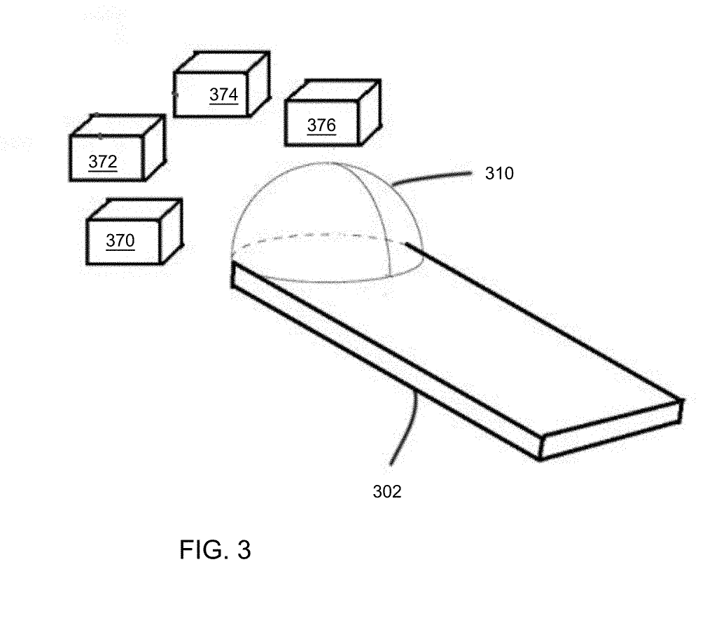

With reference to FIG. 3, another alternative embodiment is illustrated. FIG. 3 includes a remote 302 with a touch area 310. Illustrated above touch area 310 are context control menus 370, 372, 374, and 376. A holographic (or volumetric) projector projects menus 370, 372, 374, and 376 above touch area 310. Holographic (or volumetric) projector 320 may be located internal to remote 302 or located externally from remote 302.

Menus 370, 372, 374, and 376 can display a variety of different menus, including those described above. The menus can be customized by the user and can be context sensitive. The various menus described above can be present, such as shopping carts, places to get more information, and the like. In addition, the menus can control various parameters of the associated external display (not shown), such as volume, source selection, channel, brightness, color, contrast, and the like, as well as controlling playback of whatever is being viewed (for example, selecting a program, presenting a guide or other list of available selections, pausing, rewinding, fast forwarding, and the like).

In some embodiments, conditional commands can be implemented. In a conditional command, a set condition can be programmed by a user. Once the condition is met, a particular command can be implemented. For a relatively simple example, the display can be set to change channels upon the end of a sporting event or other program. For a more advanced example, if the user is watching a sporting event, the user could set up a condition, such as a touchdown being scored. Upon the occurrence of the condition, the display can change to focus on a specific area of the field (such as the fans). In another example, if a weather forecast is being displayed, a sub-menu displaying local weather is automatically displayed.

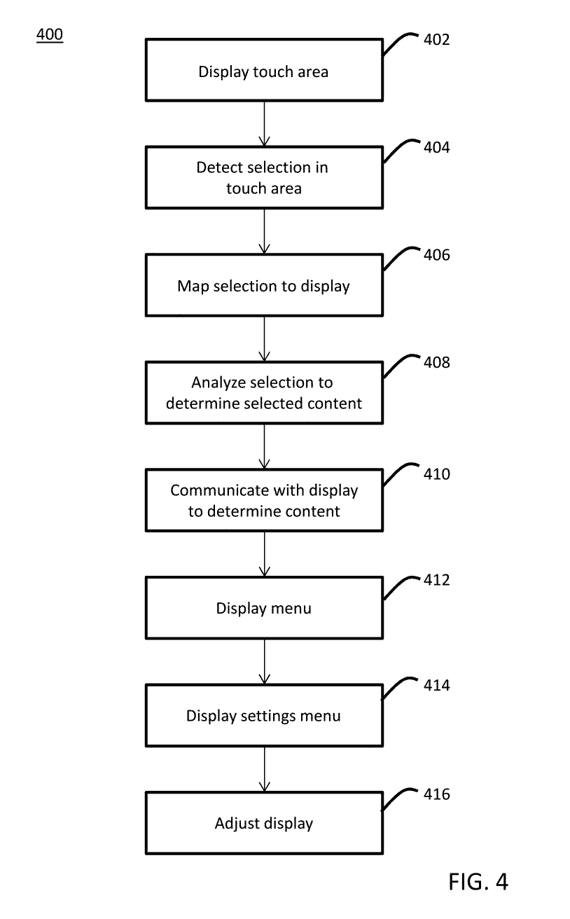

A flowchart illustrating method 400 is presented in FIG. 4. Method 400 is merely exemplary and is not limited to the embodiments presented herein. Method 400 can be employed in many different embodiments or examples not specifically depicted or described herein. In some embodiments, the procedures, processes, and/or activities of method 400 can be performed in the order presented. In other embodiments, one or more of the procedures, processes, and/or activities of method 400 can be combined or skipped. In one or more embodiments, method 400 is performed by a processor as it is executing instructions.

Method 400 depicts an operation by a user (such as user 290). A touch area is caused to be displayed by the remote (block 402). The remote detects that a user has selected a point in the touch area (block 404). The touch of the user is mapped to a location of the holographic (or volumetric) display (such as display 250) (block 406). The detection of a point can be selected in one of a variety of different methods. In some embodiments, three-dimensional sensors can be used to detect movement of the user's hands (or other pointing device used by the user).

The selection may be made visible on the screen. The detection and mapping can occur in one of a variety of different manners, such as through the use of optical sensors, three-dimensional sensors, or other motion tracking methods.

The user's selection is analyzed to determine the content that the user is attempting to select (block 408). This can be done by communicating with the holographic/volumetric display to determine what is being displayed at the portion the user is touching (block 410). Communicating with the holographic/volumetric display can include communicating with a source being displayed by the holographic/volumetric display, such as an optical disc player, Internet appliance, computer, and the like.

As discussed above, the user can be touching an object that is being displayed on the screen, in which case a menu related to the object is displayed (block 412). The menu can include holographic icons being projected from the projector installed in the TV remote. As discussed above, the context can include objects being displayed. For example, a menu bringing up shopping options could be displayed for certain items, a menu displaying information sources could be displayed for other items. In some embodiments, machine learning capabilities can be used to determine a particular user's preferences. Therefore, a different menu of choices can be displayed for two different users based on each user's previous interactions.

If the user's touch is not related to the contents being displayed but is merely the user trying to adjust settings, one or more settings menus can be displayed (block 414). If the user's touch is a gesture indicating an adjustment of the display (such as a rotation or magnification), the external display can be moved in the appropriate direction (block 416).

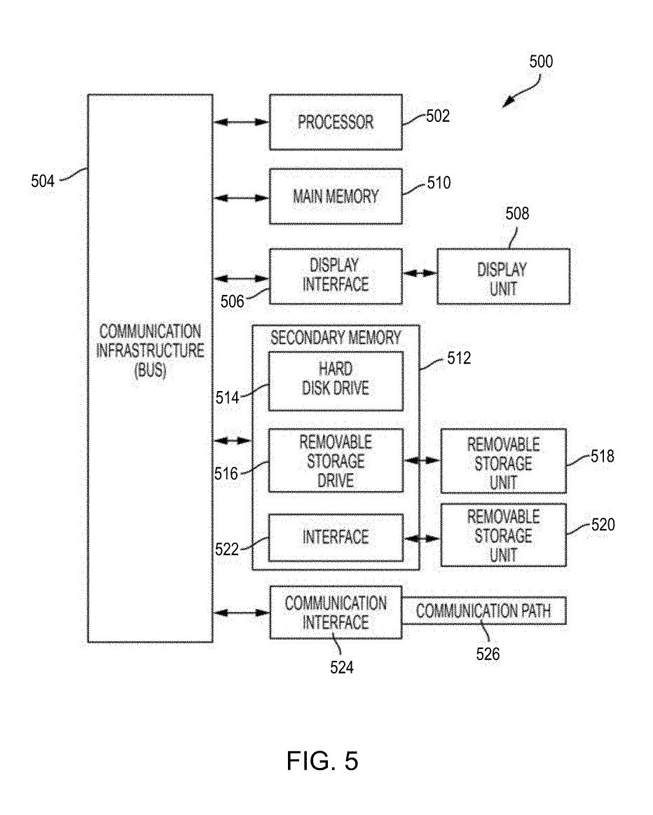

FIG. 5 depicts a high-level block diagram of a computer system 500, which can be used to implement one or more embodiments. More specifically, a remote control of one or more embodiments can include a computer system 500 or be in communication with a computer system 500. Computer system 500 can be used to implement hardware components of systems capable of performing methods described herein. Although one exemplary computer system 500 is shown, computer system 500 includes a communication path 526, which connects computer system 500 to additional systems (not depicted) and can include one or more wide area networks (WANs) and/or local area networks (LANs) such as the Internet, intranet(s), and/or wireless communication network(s). Computer system 500 and additional system are in communication via communication path 526, e.g., to communicate data between them.

Computer system 500 includes one or more processors, such as processor 502. Processor 502 is connected to a communication infrastructure 504 (e.g., a communications bus, cross-over bar, or network). Computer system 500 can include a display interface 506 that forwards graphics, textual content, and other data from communication infrastructure 504 (or from a frame buffer not shown) for display on a display unit 508. Computer system 500 also includes a main memory 510, preferably random access memory (RAM), and can also include a secondary memory 512. Secondary memory 512 can include, for example, a hard disk drive 514 and/or a removable storage drive 516, representing, for example, a floppy disk drive, a magnetic tape drive, or an optical disc drive. Hard disk drive 514 can be in the form of a solid state drive (SSD), a traditional magnetic disk drive, or a hybrid of the two. There also can be more than one hard disk drive 514 contained within secondary memory 512. Removable storage drive 516 reads from and/or writes to a removable storage unit 518 in a manner well known to those having ordinary skill in the art. Removable storage unit 518 represents, for example, a floppy disk, a compact disc, a magnetic tape, or an optical disc, etc. which is read by and written to by removable storage drive 516. As will be appreciated, removable storage unit 518 includes a computer-readable medium having stored therein computer software and/or data.

In alternative embodiments, secondary memory 512 can include other similar means for allowing computer programs or other instructions to be loaded into the computer system. Such means can include, for example, a removable storage unit 520 and an interface 522. Examples of such means can include a program package and package interface (such as that found in video game devices), a removable memory chip (such as an EPROM, secure digital card (SD card), compact flash card (CF card), universal serial bus (USB) memory, or PROM) and associated socket, and other removable storage units 520 and interfaces 522 which allow software and data to be transferred from the removable storage unit 520 to computer system 500.

Computer system 500 can also include a communications interface 524. Communications interface 524 allows software and data to be transferred between the computer system and external devices. Examples of communications interface 524 can include a modem, a network interface (such as an Ethernet card), a communications port, or a PC card slot and card, a universal serial bus port (USB), and the like. Software and data transferred via communications interface 524 are in the form of signals that can be, for example, electronic, electromagnetic, optical, or other signals capable of being received by communications interface 524. These signals are provided to communications interface 524 via a communication path (i.e., channel) 526. Communication path 526 carries signals and can be implemented using wire or cable, fiber optics, a phone line, a cellular phone link, an RF link, and/or other communications channels.

In the present description, the terms “computer program medium,” “computer usable medium,” and “computer-readable medium” are used to refer to media such as main memory 510 and secondary memory 512, removable storage drive 516, and a hard disk installed in hard disk drive 514. Computer programs (also called computer control logic) are stored in main memory 510 and/or secondary memory 512. Computer programs also can be received via communications interface 524. Such computer programs, when run, enable the computer system to perform the features discussed herein. In particular, the computer programs, when run, enable processor 502 to perform the features of the computer system. Accordingly, such computer programs represent controllers of the computer system. Thus it can be seen from the foregoing detailed description that one or more embodiments provide technical benefits and advantages.

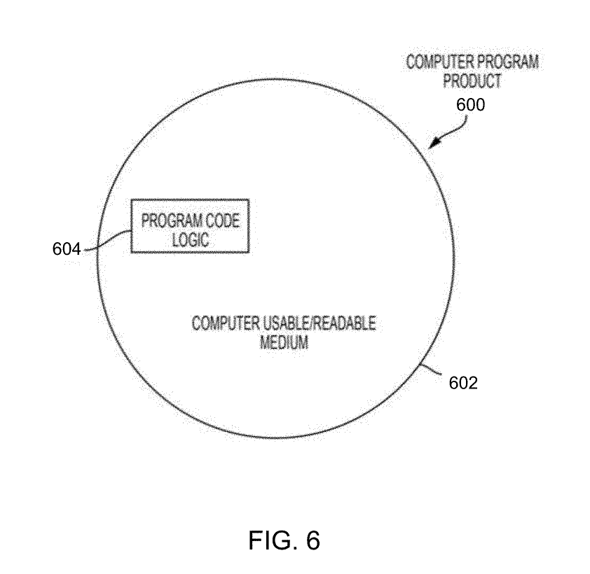

Referring now to FIG. 6, a computer program product 600 in accordance with an embodiment that includes a computer-readable storage medium 602 and program instructions 604 is generally shown.

Embodiments can be a system, a method, and/or a computer program product. The computer program product can include a computer-readable storage medium (or media) having computer-readable program instructions thereon for causing a processor to carry out aspects of embodiments of the present invention.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out embodiments can include assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer-readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform embodiments of the present invention.

Aspects of various embodiments are described herein with reference to flowchart illustrations and/or block diagrams of methods, apparatus (systems), and computer program products according to various embodiments. It will be understood that each block of the flowchart illustrations and/or block diagrams, and combinations of blocks in the flowchart illustrations and/or block diagrams, can be implemented by computer-readable program instructions.

These computer-readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The descriptions presented herein are for purposes of illustration and description, but is not intended to be exhaustive or limited. Many modifications and variations will be apparent to those of ordinary skill in the art without departing from the scope and spirit of embodiments of the invention. The embodiment was chosen and described in order to best explain the principles of operation and the practical application, and to enable others of ordinary skill in the art to understand embodiments of the present invention for various embodiments with various modifications as are suited to the particular use contemplated.

What is claimed is:

1. A remote control for controlling a volumetric display, the remote control comprising:
a memory;
a processor system communicatively coupled to the memory; and
a holographic display; and
the processor system configured to perform a method comprising:
displaying a hemispheric touch area using the holographic display;
detecting a selection in the hemispheric touch area;
mapping the selection to the volumetric display controlled by the remote control; and
controlling the volumetric display based on the selection in the hemispheric touch area.

2. The remote control of claim 1, wherein controlling the volumetric display based on the selection comprises:
analyzing content being displayed by the volumetric display controlled by the remote control.

3. The remote control of claim 2 wherein:
analyzing content comprises communicating with the volumetric display to determine what is being displayed.

4. The remote control of claim 2 wherein:
controlling the volumetric display comprises causing a display of a menu based on the analyzed content.

5. The remote control of claim 4 wherein:
the menu is configured to control display of material related to the analyzed content.

6. The remote control of claim 5 wherein:
the material related to the analyzed content comprises vendor information to buy or sell products related to the analyzed content.

7. The remote control of claim 2 wherein the processor system is further configured to:
receive a condition to detect;
upon detection of the condition performing a predetermined action, wherein the condition is detected by analyzing content being displayed by the volumetric display.

8. The remote control of claim 7, wherein the predetermined action includes controlling the volumetric display.

9. The remote control of claim 1, wherein controlling the volumetric display based on the selection comprises:
upon detection of a rotation gesture in the hemispheric touch area, causing rotation of the volumetric display; and
upon detection of a zoom gesture in the hemispheric touch area, causing zoom of the volumetric display.

10. A method for controlling a volumetric display via a remote control, the method comprising:
displaying a hemispheric touch area in a vicinity of the remote control;
detecting a selection in the hemispheric touch area;
mapping the selection to the volumetric display controlled by the remote control; and
controlling the volumetric display based on the selection in the hemispheric touch area.

11. The method of claim 10, wherein controlling the volumetric display based on the selection comprises:
analyzing content being displayed by the volumetric display controlled by the remote control.

12. The method of claim 11 wherein:
analyzing content comprises communicating with the volumetric display to determine what is being displayed.

13. The method of claim 11 wherein:
controlling the volumetric display comprises causing a display of a menu based on the analyzed content.

14. The method of claim 13 wherein:
the menu is configured to control display of material related to the analyzed content.

15. The method of claim 14 wherein:
the material related to the analyzed content comprises vendor information to buy or sell products related to the analyzed content.

16. The method of claim 11 further comprising:
receiving a condition to detect;
upon detection of the condition performing a predetermined action, wherein the condition is detected by analyzing content being displayed by the volumetric display.

17. The method of claim 16, wherein the predetermined action includes controlling the volumetric display.

18. The method of claim 10, wherein controlling the volumetric display based on the selection comprises:
upon detection of a rotation gesture in the hemispheric touch area, causing rotation of the volumetric display; and
upon detection of a zoom gesture in the hemispheric touch area, causing zoom of the volumetric display.

19. A computer program product for remotely controlling a volumetric display comprising:
a computer-readable storage medium having program instructions embodied therewith, wherein the computer-readable storage medium is not a transitory signal per se, the program instructions readable by a processor system to cause the processor system to perform a method comprising:
displaying a hemispheric touch area in a vicinity of a remote control;
detecting a selection in the hemispheric touch area;
mapping the selection to the volumetric display controlled by the remote control; and
controlling the volumetric display based on the selection in the hemispheric touch area.

20. The computer program product of claim 19, wherein controlling the volumetric display based on the selection comprises:
analyzing content being displayed by the volumetric display controlled by the remote control.
